(19) United States
(12) Patent Application Publication
(10) Pub. No.: US 2017/0338450 A1
(43) Pub. Date: Nov. 23, 2017

(54) SECONDARY ELECTROCHEMICAL BATTERY SEALING BODY WITH CHARGING INDICATOR

(71) Applicant: FUJIAN NANPING NANFU BATTERY CO., LTD., Fujian (CN)

(72) Inventors: Haitao Chang, Fujian (CN); Jintian Chen, Fujian (CN); Sheng Su, Fujian (CN); Yongfeng Ye, Fujian (CN); Youfeng Yu, Fujian (CN); Xiaochun Xu, Fujian (CN)

(21) Appl. No.: 15/672,795

(22) Filed: Aug. 9, 2017

Related U.S. Application Data
(63) Continuation of application No. PCT/CN2015/096610, filed on Dec. 8, 2015.

(30) Foreign Application Priority Data
Jun. 12, 2015 (CN) 2015103241165
Jun. 12, 2015 (CN) 2015204065429

(51) Int. Cl. H01M 2/08; H02J 7/00; H01M 10/0525

(52) U.S. Cl. CPC H01M 2/08; H02J 7/0047; H01M 10/0525; H02J 2007/005; H02J 2007/0049

(57) ABSTRACT

A secondary electrochemical battery sealing body, including a negative electrode cap, a circuit board module and an insulating washer. The circuit board module is connected to the negative electrode cap via a connecting member. A charge indicator is disposed on the circuit board module at the position corresponding to an edge of the negative electrode cap. A notch is formed on the edge of the negative electrode cap as a light transmission port of the charge indicator. The notch has a height which does not exceed the height of the negative electrode cap. The insulating washer is a flexible and elastic annular insulating gasket, and is disposed in a gap between a battery housing, the circuit board module and the negative electrode cap. The insulating washer completely covers the light transmission port of the charge indicator to seal the negative electrode cap, the battery housing and the circuit board module.

### CROSS-REFERENCE TO RELATED APPLICATION

This application is a continuation application of International Patent Application No. PCT/CN2015/096610, filed on Dec. 8, 2015, which itself claims priority to Chinese Patent Application Nos. 2015103241165 and 2015204065429, filed on Jun. 12, 2015 in the State Intellectual Property Office of P.R. China, which are hereby incorporated herein in their entireties by reference.

### FIELD OF THE INVENTION

The present invention relates to a secondary battery, and in particular to a secondary electrochemical battery sealing body with a charging indicator.

### BACKGROUND OF THE INVENTION

In recent years, a secondary battery (also referred to as a rechargeable battery) has been widely applied to various portable electrical equipment and electronic equipment, such as toys and handheld equipment, which proposes an increasingly high requirement on energy storage of the secondary battery. A lithium-ion secondary battery is gradually applied to the foregoing field due to advantages of high energy, high power discharge, environmental protection, and the like.

Normal operation of the rechargeable battery often needs to cooperate with an integrated circuit chip having other functions, so as to achieve a desired working effect. Generally, the rechargeable battery and the integrated circuit chip are separately encapsulated, and then connected by using a circuit board and a conducting wire to be used in combination. Thus there are lots of peripheral elements and production processes, causing high costs, large sized rechargeable battery and integrated circuit chip as well as poor performance, which are detrimental to minimization and miniaturization.

During encapsulation of the lithium-ion secondary battery, each part of the lithium-ion secondary battery occupies fixed space. A polymer battery core includes inside a positive electrode pole piece, an isolating membrane and a negative electrode pole piece. At an end of the positive electrode pole piece that faces away from the isolating membrane, there is a battery core top seal having a specified height for encapsulation. Because the battery core top seal occupies a certain height of the polymer battery core, available space in the polymer battery core is reduced. However, space utilization of the polymer battery core is closely related to energy density and capacity of the lithium-ion secondary battery. Generally, greater space utilization of the polymer battery core indicates larger energy density and capacity of the lithium-ion secondary battery. Therefore, among existing lithium-ion secondary batteries, there is a ubiquitous problem that energy density and capacity of the lithium-ion secondary battery are low due to poor space utilization of the polymer battery core.

### SUMMARY OF THE INVENTION

The present invention provides a secondary electrochemical battery sealing body with a charging indicator. The sealing body is configured to seal an opening of a battery housing of a secondary electrochemical battery, wherein the sealing body includes: a negative electrode cap, a circuit board module and an insulating washer. The negative electrode cap is located on an outermost side of the battery sealing body, and the circuit board module is located on an inner side of the negative electrode cap, and connected to the negative electrode cap via a connecting piece. A charging indicator is disposed on a place that is on the circuit board module and that corresponds to an edge of the negative electrode cap. A portion where the negative electrode cap and the circuit board module are connected is a “C” shaped annular structure in shape, that is, a notch is formed on the edge of the negative electrode cap, the notch is a light transmission port of the charging indicator, the notch has a certain height but is not higher than the negative electrode cap, so that the charging indicator is exposed, and a position of the notch corresponds to a position of the charging indicator on the circuit board module. The insulating washer is a flexible and elastic annular insulating gasket, and disposed in a gap between the battery housing, the circuit board module and the negative electrode cap, with a part configured to compress against and secure the circuit board module, and the other part configured to isolate the battery housing from the negative electrode cap, the insulating washer further completely covers the light transmission port of the charging indicator, to seal the negative electrode cap, the battery housing and the circuit board module, and the insulating washer is made of a transparent light guide material, so that light emitted by the charging indicator passes through the insulating washer, and the entire insulating washer is rendered to transmit the light.

Preferably, the charging indicator has at least one color.

Preferably, when the charging indicator has one color, the charging indicator constantly turns on in the color during charging, and turns off when charging is complete.

Preferably, when the charging indicator has two colors, the charging indicator constantly turns on in one color during charging, and constantly turns on in the other color when charging is complete.

Preferably, when charging becomes abnormal during charging due to a fault, the charging indicator blinks.

Preferably, in earlier, intermediate, later stages of charging, the charging indicator blinks at a descending frequency, and the charging indicator constantly turns on when charging is complete.

Preferably, the circuit board module and the negative electrode cap are soldered.

Preferably, a circuit negative electrode output of the circuit board module is disposed at where the negative electrode cap and the circuit board are connected, so that a same wire is used for negative electrode output and circuit grounding.

Preferably, a portion where the insulating washer is in contact with the battery housing is arc shaped, to fit an arc structure of the battery housing.

Preferably, the sealing body is configured to seal the opening of the battery housing of the secondary electrochemical battery, and the battery further includes a battery core and a positive electrode cap. The positive electrode cap is connected to the battery housing to form a positive electrode of the secondary battery. The battery core is placed in the battery housing, and located between the positive electrode cap and the circuit board module.

The secondary electrochemical battery sealing body with a charging indicator according to this invention has an appropriate structural design. The charging indicator is disposed on the circuit board of the electrochemical battery, which is to be used in conjunction with the transparent insulating washer on the battery negative electrode, so that the entire insulating washer is rendered to transmit light during battery charging. Therefore, light indicating charging is more visible.

### BRIEF DESCRIPTION OF THE DRAWINGS

Additional objectives, functions and advantages of this invention are set forth in the following description of the implementation of this invention with reference to the accompanying drawings. In the accompanying drawings:

FIG. 1A is a sectional exploded view of a sealing body for an electrochemical battery according to this invention;

FIG. 1B is a three-dimensional view of a sealing body for an electrochemical battery according to this invention;

FIG. 1C is a top view of a sealing body for an electrochemical battery according to this invention;

FIG. 2A is a schematic structural view schematically showing an electrochemical battery according to this invention;

FIG. 2B is an exploded perspective view of an electrochemical battery according to this invention; and

FIG. 2C is a cross-sectional view along an A-A direction in FIG. 1A.

### DETAILED DESCRIPTION OF THE INVENTION

Objectives, functions, and methods for implementing the objectives and functions according to this invention are described by reference to exemplary embodiments. However, this invention is not limited to the exemplary embodiments disclosed below, and may be implemented in different forms. This specification is merely intended to help those skilled in related art to comprehensively understand specific details of this invention.

It should be understood that, both the general description above and the detailed description below are exemplary descriptions and explanations, and should not be construed as a limitation to what is claimed in this invention.

The embodiments of this invention are described below with reference to the accompanying drawings. In the accompanying drawings, same reference numerals represent same or similar components, or same or similar steps.

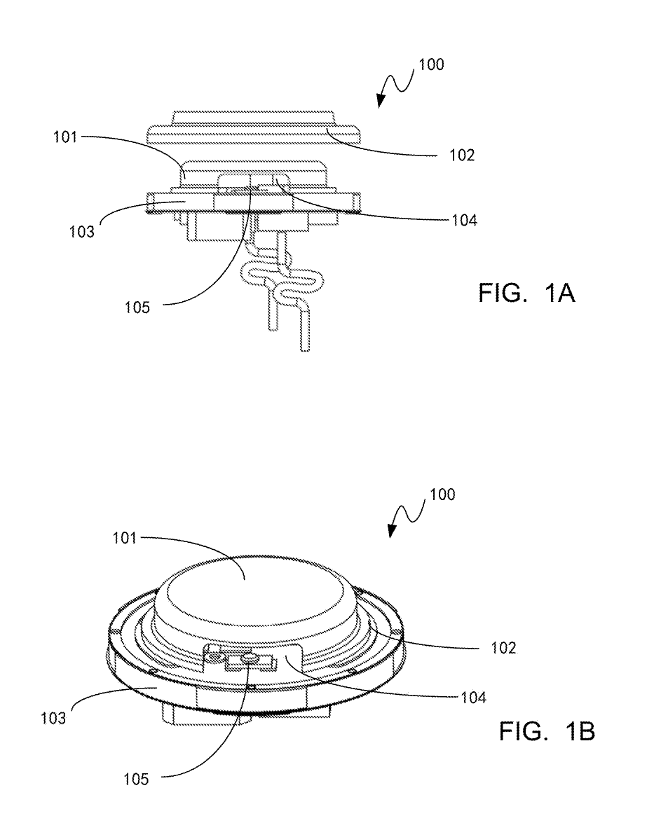

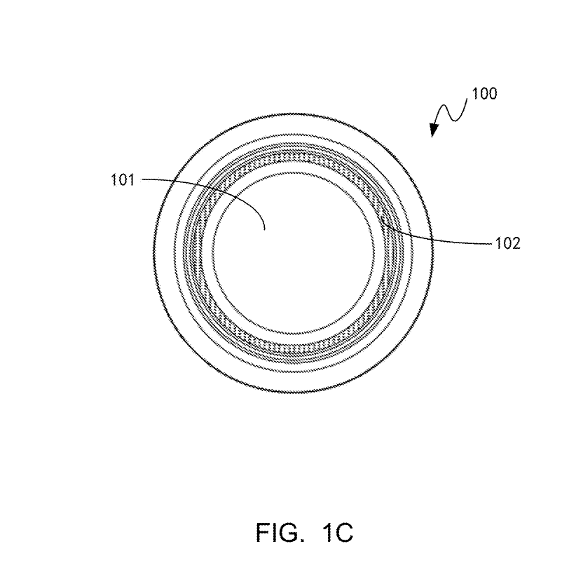

This invention provides a secondary electrochemical battery sealing body with a charging indicator. FIG. 1A is a sectional exploded view of a secondary electrochemical battery sealing body 100 with a charging indicator according to this invention. FIG. 1B is a three-dimensional view of the secondary electrochemical battery sealing body 100 with a charging indicator according to this invention. As shown in FIG. 1A, the sealing body 100 includes a negative electrode cap 101, an insulating washer 102, and a circuit board module 103. The negative electrode cap 101 is located on an outermost side of the battery sealing body 100. The circuit board module 103 is located on an inner side of the negative electrode cap 101, and connected to the negative electrode cap 101 via a connecting piece. The insulating washer 102 is disposed in a gap between the circuit board module 103 and the negative electrode cap 101.

A charging indicator 105 is disposed on a place that is on the circuit board module 103 and that corresponds to an edge of the negative electrode cap 101. The charging indicator 105 is an indicator having at least one color. If the charging indicator 105 has one color, the charging indicator 105 constantly turns on in the color during charging, and turns off when charging is complete. If the charging indicator 105 has two colors, the charging indicator 105 constantly turns on in one color during charging, and constantly turns on in the other color when charging is complete. When the battery cannot be charged normally during charging due to a fault, the charging indicator blinks, for example, blinks five times per second. In earlier (for example, 30%), intermediate (for example, 30% to 60%), and later (for example, 60% to 99%) stages of charging, the charging indicator blinks at a descending frequency. When charging is complete, the charging indicator constantly turns on. For example, during charging, before battery level reaches 30%, the charging indicator 105 blinks three times per second. When the level ranges from 30% to 60%, the charging indicator 105 blinks twice per second. When the level ranges from 60% to 99%, the charging indicator 105 blinks once per second. When charging is complete, the charging indicator 105 constantly turns on.

A portion where the negative electrode cap 101 and the circuit board module 103 are connected is a “C” shaped annular structure in shape, that is, a notch 104 is formed on the edge of the negative electrode cap 101. The notch 104 is a light transmission port of the charging indicator 105. The notch 104 has a certain height but is not higher than the negative electrode cap, so that the charging indicator 105 is exposed. A position of the notch 104 corresponds to a position of the charging indicator 105 on the circuit board module 103. The insulating washer 102 is a flexible and elastic annular insulating gasket, and can completely cover the light transmission port of the charging indicator 105 (as shown in FIG. 1C). The insulating washer 102 is made of a transparent light guide material, so that light emitted by the charging indicator 105 can pass through the insulating washer, and the entire insulating washer is rendered to transmit the light.

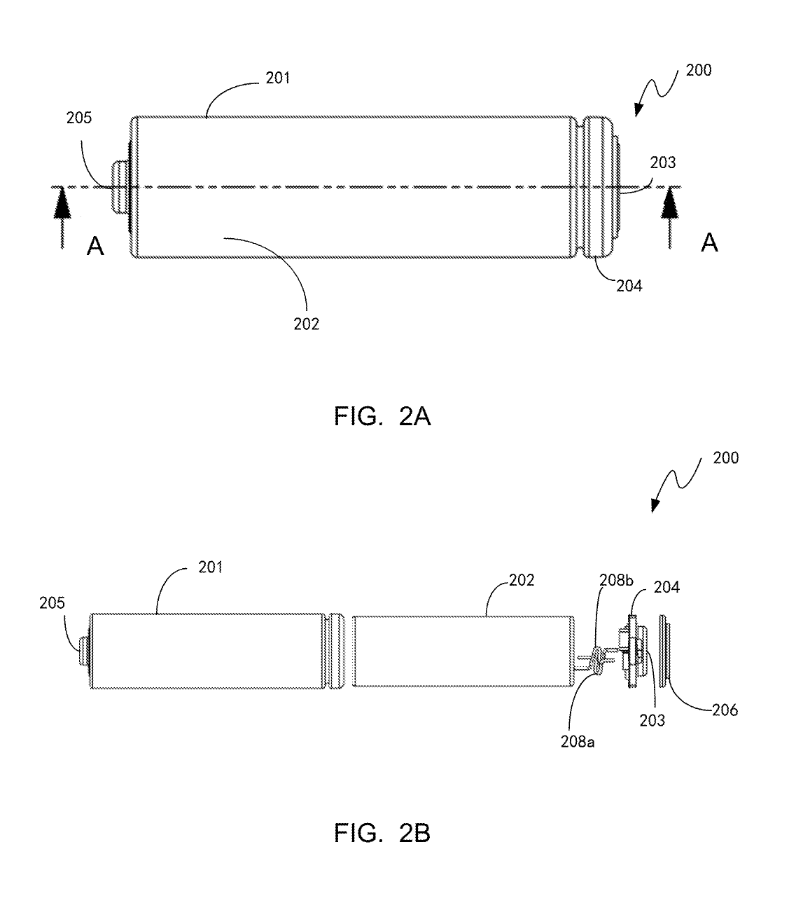

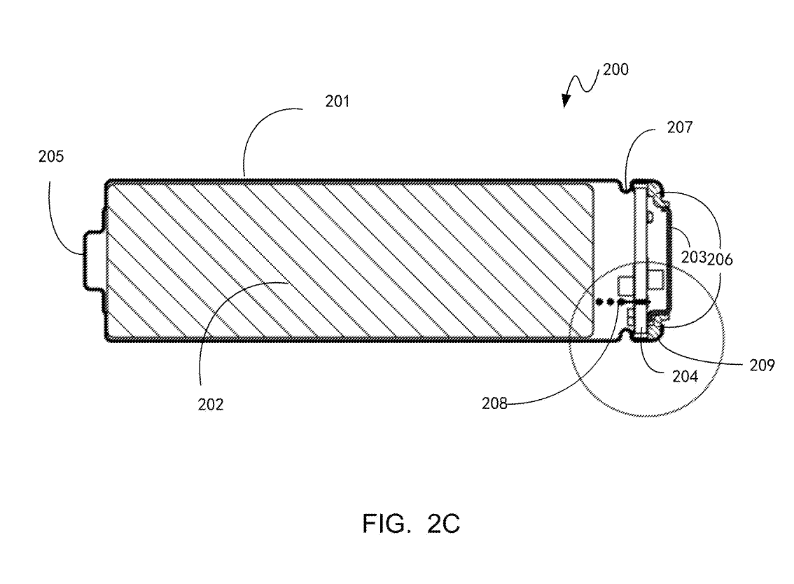

FIG. 2A and FIG. 2B are respectively a schematic structural diagram and an exploded perspective diagram of an electrochemical battery 200 including the secondary electrochemical battery sealing body with a charging indicator according to this invention. As shown in FIG. 2A and FIG. 2B, the electrochemical battery 100 includes: a battery housing 201, a battery core 202 placed in the battery housing 201, a negative electrode cap 203, a circuit board module 204 placed in space between the battery core 202 and the negative electrode cap 203, and a positive electrode cap 205. The battery core 202 is housed by the battery housing 201, and located between the positive electrode cap 205 and the circuit board module 204. The battery housing 201 is a cylindrical or cuboid steel shell, and configured as an positive electrode output, and configured to secure the circuit board module 204. According to an embodiment of this invention, the positive electrode cap 205 is rotated to the right to be integrally structured with the battery housing 201, so as to form an positive electrode of the secondary battery 200.

The circuit board module 204 is a printed circuit board (PCB) of at least one layer, and has a first side and a second side. The first side points to the negative electrode cap 203 relative to the electrochemical battery 200, and the second side points to the battery core 202 relative to the electrochemical battery 200. The PCB is a circuit board on which a wiring pattern is printed, and is sized to approximately corresponds to an inner diameter of the housing of the battery 200. Multiple printed conducting wire and elements are arranged on the first side or the second side of the circuit board module 204.

The circuit board module 204 is close to the negative electrode cap 203 side of the battery 200, and located between the battery core 202 and the negative electrode cap 203. The circuit board module 204 is provided with a connecting piece thereon to secure the negative electrode cap 203 onto the circuit board module 204. For example, the negative electrode cap 203 may be soldered onto the circuit board module 204, or may be secured by snap fitting, etc. A circuit negative electrode output of the circuit board module 204 is disposed at where the negative electrode cap 203 and the circuit board are connected, so that a same wire is used for negative electrode output and circuit grounding.

Electrode connecting wires 208a and 208b are disposed between the circuit board module 204 and the battery core 202, to respectively lead out positive and negative electrodes of the battery. 208a is a positive electrode connecting wire. 208b is a negative electrode connecting wire. FIG. 2C is a cross-sectional view along an A-A direction in FIG. 2A. An insulating washer 206 is disposed between the circuit board module 204 and the external battery housing 201 and between the negative electrode cap 203 and the battery housing 201. The insulating washer 206 is a flexible and elastic annular insulating gasket. The insulating washer 206 can isolate the battery housing 201 functioning as a first electrode from the negative electrode cap 203 functioning as a second electrode, and the insulating washer 206 can compress against and secure the circuit board module 204 due to its elasticity, so as to seal a gap between the battery housing 201 and the negative electrode cap 203. Specifically, as shown in FIG. 2C, a part of the insulating washer 206 is configured to compress against the circuit board module 204 and secure the circuit board module 204 between turns 207 and the battery housing 201, and the other part is configured to isolate the battery housing 201 from the negative electrode cap 203.

A lap of inward annular recess, that is, turns 207, is formed at a position that is on an outer surface of the battery housing 201 and that corresponds to a position between the battery core 202 and the printed circuit board 206. The battery core 202 is placed in the battery housing 201, and located between the positive electrode cap 205 and the turns 207. The insulating washer 206 and the turns 207 are disposed so that the circuit board module 204 is secured between the annular recess of the battery housing 201 and a bottom of the battery housing 201. Therefore, the battery housing 201 and the negative electrode cap 203 can be connected without welding.

The Turns 207 is disposed for locating the circuit board module 204. Specifically, a diameter of the circuit board module 204 is sized between an inner diameter of the annular recess formed by the turns 207 and an inner diameter of the battery housing 201. During battery assembly, the battery core 202 is first placed in the battery housing 201, then the circuit board module 204 is placed in the battery housing 201. The circuit board module 204 is sized to be stuck at turns 207, thereby preventing from contacting the battery core 202. Next, the battery housing 201 is isolated from the negative electrode cap 203 by the insulating washer 206, thus completing assembly of the battery 200. With the foregoing structure, the circuit board module 204 forms closed space inside the battery housing 201 by means of turns 207, for accommodating the battery core 202, which can increase the volume of the battery core 202 and increase capacity of the secondary battery. Preferably, the battery core 202 is of a sealed structure, and positive and negative electrodes of the battery core 202 are led out of the battery core 202 to connect with the corresponding positive and negative electrodes of the battery for operation.

Preferably, said turns 207 is recessed 0.2 to 1.2 mm relative to the surface of the battery housing 201.

The secondary electrochemical battery sealing body with a charging indicator according to this invention has an appropriate structural design. The charging indicator is disposed on a circuit board of the electrochemical battery, which is to be used in conjunction with the transparent insulating washer on the battery negative electrode, so that the entire insulating washer is rendered to transmit light during battery charging. Therefore, light indicating charging is more visible.

In connection with the description and practice of this invention disclosed herein, other embodiments of this invention will easily occur to and be understood by those skilled in the art. The description and embodiments are merely considered to be exemplary, with a true scope and spirit of this invention being defined by the claims.

What is claimed is:

1. A secondary electrochemical battery sealing body with a charging indicator, wherein the sealing body is configured to seal an opening of a battery housing of the secondary electrochemical battery, and the sealing body comprises a negative electrode cap, a circuit board module and an insulating washer,
the negative electrode cap is located on an outermost side of the battery sealing body, and the circuit board module is located on an inner side of the negative electrode cap, and connected to the negative electrode cap via a connecting piece;
a charging indicator is disposed on a place that is on the circuit board module and that corresponds to an edge of the negative electrode cap;
a portion where the negative electrode cap and the circuit board module are connected is a “C” shaped annular structure in shape, that is, a notch is formed on the edge of the negative electrode cap, the notch is a light transmission port of the charging indicator, the notch has a certain height but is not higher than the negative electrode cap, so that the charging indicator is exposed, and a position of the notch corresponds to a position of the charging indicator on the circuit board module; and
the insulating washer is a flexible and elastic annular insulating gasket, and disposed in a gap between the battery housing, the circuit board module and the negative electrode cap, with a part configured to compress against and secure the circuit board module, and the other part configured to isolate the battery housing from the negative electrode cap, the insulating washer further completely covers the light transmission port of the charging indicator, to seal the negative electrode cap, the battery housing and the circuit board module, and the insulating washer is made of a transparent light guide material, so that light emitted by the charging indicator passes through the insulating washer, and the entire insulating washer is rendered to transmit the light;
the circuit board module is a printed circuit board of at least one layer.

2. The secondary electrochemical battery sealing body according to claim 1, wherein the charging indicator has at least one color.

3. The secondary electrochemical battery sealing body according to claim 2, wherein when the charging indicator has one color, the charging indicator constantly turns on in the color during charging, and turns off when charging is complete.

4. The secondary electrochemical battery sealing body according to claim 2, wherein when the charging indicator has two colors, the charging indicator constantly turns on in one color during charging, and constantly turns on in the other color when charging is complete.

5. The secondary electrochemical battery sealing body according to claim 2, wherein when charging becomes abnormal during charging due to a fault, the charging indicator blinks.

6. The secondary electrochemical battery sealing body according to claim 2, wherein in earlier, intermediate, later stages of charging, the charging indicator blinks at a descending frequency, and the charging indicator constantly turns on when charging is complete.

7. The secondary electrochemical battery sealing body according to claim 1, wherein the circuit board module and the negative electrode cap are soldered.

8. The secondary electrochemical battery sealing body according to claim 1, wherein a circuit negative electrode output of the circuit board module is disposed at where the negative electrode cap and the circuit board are connected, so that a same wire is used for negative electrode output and circuit grounding.

9. The secondary electrochemical battery sealing body according to claim 1, wherein a portion where the insulating washer is in contact with the battery housing is arc shaped, to fit an arc structure of the battery housing.

10. A secondary electrochemical battery comprising the battery sealing body according to claim 1, wherein the sealing body is configured to seal an opening of a battery housing of the secondary electrochemical battery, and the battery further comprises a battery core and a positive electrode cap, wherein,
the positive electrode cap is connected to the battery housing to form a positive electrode of the secondary battery; and
the battery core is placed within the battery housing, and located between the positive electrode cap and the circuit board module.
